(19) United States
(12) Patent Application Publication
(10) Pub. No.: US 2003/0026037 A1
(43) Pub. Date: Feb. 6, 2003

(54) Method and system for providing electronics inside of a disk drive having a compact flash form factor

(76) Inventors: A. William O'Sullivan, Santa Clara, CA (US); Henry Hazebrouck, Sunnyvale, CA (US); Charles Kim, Los Gatos, CA (US); Michael Andrews, Santa Cruz, CA (US)

Correspondence Address: SAWYER LAW GROUP LLP, P.O. Box 51418, Palo Alto, CA, 94303, US

(21) Appl. No.: 09/919,459

(22) Filed: Jul. 31, 2001

(51) Int. Cl. G11B 17/00

(52) U.S. Cl. 360/97.01

(57) ABSTRACT

A method and system for providing a disk drive for storing and retrieving data is disclosed. The method and system include providing a housing, a motor, a head, an actuator, a flex circuit having electronics including at least one integrated circuit and an external electrical interface. The housing has a cavity therein. The motor is coupled with a disk that stores the data and is for spinning the disk. The actuator is coupled with the head and is for moving the head between the inner and outer recording radii of the disk. The electronics are coupled with the head. The electronics are for controlling the actuator and the head and for providing a write signal to and a read signal from the head. The disk, the motor, the head, the actuator, and the electronics are contained within the cavity of the housing. The housing and the external electrical interface are compatible with a reduced size standard.

### RELATED APPLICATIONS

The present invention is related to co-pending U.S. patent application Ser. No. 09/321,065 filed on May 27, 1999, entitled “Method and System for Providing a Disk Drive in a Compact Flash Form Factor” and assigned to the assignee of the present application.

### FIELD OF THE INVENTION

The present invention relates to disk drives, and more particularly to a method and system for providing a disk drive having electronics within the drive and which has a CompactFlash™ form factor.

### BACKGROUND OF THE INVENTION

Data may be stored using a variety of conventional mechanisms. One conventional storage device is a conventional disk drive. In the conventional disk drive, data is magnetically stored on a disk. In many conventional floppy disk drives, for example for desktop or laptop computers, the disk is typically on the order of three and one half inches in diameter. Such a conventional disk is capable of storing 4 megabytes (MB) of data. Similarly, hard disks existing within computers are typically larger and capable of storing up to several gigabytes of data. Furthermore, such storage devices utilize conventional electronics that utilize a rigid printed circuit board assembly (PCBA) as a base, or substrate. The PCBA is made of FR4 material.

Although conventional disk drives function, it is desirable for the storage device to be smaller. For example, apparatus for many applications are designed to be portable. Digital cameras, which store data digitally rather than on film, and personal digital assistants are examples of two such applications. The storage device for such applications is desired to be small and portable. Conventional disk drives, even conventional floppy disk drives, are larger than desired for such applications. Therefore, smaller storage devices are desired for many applications. Because many current applications use portable devices, it would also be desirable for the smaller storage devices to consume a reduced amount of power.

Standards have been proposed for applications utilizing smaller storage devices. For example, Personal Computer Memory Card International Association (PCMCIA) has proposed a PCMCIA compatible device known as a PC card. The Type II PC cards are typically used for memory. A Type II PC card is 85.6 mm long by 54 mm wide, approximately five millimeters thick, and utilizes a sixty-eight pin electrical interface that is ATA (AT attachment) compatible. Thus, Type II PC cards can be used for providing a smaller storage device.

In order to provide an even smaller storage device, the CompactFlash™ standard has been developed. The CompactFlash™ standard was originally introduced by SanDisk Corporation in 1994. The CompactFlash™ standard utilizes a conventional CompactFlash™ card (conventional CF card) for storage. The conventional CF card includes semiconductor memory as well as an electrical interface for plugging the conventional CF card into a device. The semiconductor memory includes multiple memory cells on one or more semiconductor chips. The conventional CF card has dimensions of 42.8 mm×36.4 mm×3.3 mm. The thickness of the conventional CF card is thus approximately half that of a PCMCIA type II card. The conventional CF card has a fifty pin electrical interface that conforms to ATA (AT attachment) specifications. Thus, although a PCMCIA card has sixty-eight pins, the conventional CF card can be used with a passive adapter for PCMCIA standards. Thus, the conventional CF card can be utilized with CompactFlash™ compatible or PCMCIA compatible devices.

Although the conventional CF card provides a small storage device, there are drawbacks to its use. The small size of the conventional CF card for the CompactFlash™ standard limits the number of semiconductor chips that can be placed in the conventional CF. However, many conventional applications utilize a relatively large amount of memory. A conventional CF card storing one bit per memory cell may be incapable of providing the desired amount of memory for such conventional applications.

To provide the desired amount of memory at the size of the conventional CF card, multiple bits are stored in each memory cell of the semiconductor chips. For example, four bits may be store in each memory cell. To write to a cell thus requires quadruple the time taken to write a memory cell which stores a single bit. The conventional CF card having four-bit memory cells can typically write approximately one hundred kilobytes per second. As discussed above, some conventional applications require relatively large amounts of memory. In addition, individual files stored by some conventional applications are relatively large. For example, conventional digital cameras currently compress images to files of approximately seven hundred kilobytes in size. It would require approximately seven seconds to store a single image file using a conventional CF card which has four-bit memory cells in semiconductor flash memory. Thus, access times for such a conventional CF card may be relatively slow.

Furthermore, the use of conventional electronics provided on a PCBA board used in a conventional disk drive storage device is precluded. The substrate, the PCBA board, has a range of thicknesses that is required to be from 0.45 mm to 1.25 mm. The conventional electronics that are used are placed on top of the PCBA board, increasing the thickness of the electronics for the conventional storage device. This large height precludes the use of such conventional electronics in the CompactFlash™ 42.8 mm×36.4 mm×3.3 mm form factor.

Accordingly, what is needed is a system and method for providing a disk drive compatible with a reduced size standard, such as a CompactFlash™. The present invention addresses such a need.

### SUMMARY OF THE INVENTION

The present invention provides a method and system for providing a disk drive for storing and retrieving data. The method and system comprise providing a housing, a motor, a head, an actuator, a flex circuit having electronics including at least one integrated circuit and an external electrical interface. The housing has a cavity therein. The motor is coupled with a disk that stores the data and is for spinning the disk. The actuator is coupled with the head and is for moving the head in proximity to the disk. The electronics are coupled with the head. The electronics are for controlling the actuator and the head and for providing a write signal to and a read signal from the head. The disk, the motor, the head, the actuator, and the electronics are contained within the cavity of the housing. The housing and the external electrical interface are compatible with a reduced size standard.

According to the system and method disclosed herein, the present invention provides a disk drive that is compatible and can be utilized with reduced size interfaces.

### BRIEF DESCRIPTION OF THE DRAWINGS

FIG. 1A is an external view of one embodiment of a disk drive in accordance with the present invention.

FIG. 1B is a diagram of one embodiment of a disk drive, including internal portions of the disk drive, in accordance with the present invention.

FIG. 2A is a diagram of one embodiment of the electronics for a disk drive in accordance with the present invention prior to assembly.

FIG. 2B is a diagram of one embodiment of the electronics for a disk drive in accordance with the present invention prior to attachment to the cover.

FIG. 2C is a diagram of one embodiment of the electronics for a disk drive in accordance with the present invention as assembled.

FIG. 2D is a diagram of one embodiment of internal portions of the disk drive in accordance with the present invention.

FIG. 3 is an exploded view of one embodiment of internal portions of the disk drive in accordance with the present invention.

### DETAILED DESCRIPTION OF THE INVENTION

The present invention relates to an improvement in disk drives. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention is related to co-pending U.S. patent application Ser. No. 09/321,065 filed on May 27, 1999, entitled “Method and System for Providing a Disk Drive in a Compact Flash Form Factor” and assigned to the assignee of the present application. Applicant hereby incorporates by reference the above-mentioned patent application. The disk drive described in the above-mentioned co-pending application is compatible with a reduced size standard, such as a CompactFlash™ standard. The disk drive includes the disk, actuator and associated components in one cavity in a housing, while the electronics are housed in a separate cavity. Although the disk drive described in the above-mentioned co-pending patent application functions well for its intended purpose, one of ordinary skill in the art will readily recognize that further integration and development of a disk drive compatible with a reduced size standard is desirable to improve performance of such a disk drive and ensure its compatibility and improved performance with the desired reduced size standard.

The present invention provides a method and system for providing a disk drive for storing and retrieving data. The method and system comprise providing a housing, a motor, a head, an actuator, a flex circuit having electronics including at least one integrated circuit and an external electrical interface. The housing has a cavity therein. The motor is coupled with a disk that stores data and is for spinning the disk. The actuator is coupled with the head and is for moving the head in proximity to the disk. The electronics are coupled with the head. The electronics are for controlling the actuator and the head and for providing a write signal to and a read signal from the head. The disk, the motor, the head, the actuator, and the electronics are contained within the cavity of the housing. The housing and the external electrical interface are compatible with a reduced size standard.

The present invention will be described in terms of a disk drive having certain components in a particular arrangement. However, one of ordinary skill in the art will readily recognize that this method and system will operate effectively for other components or other arrangements of the components of the disk drive.

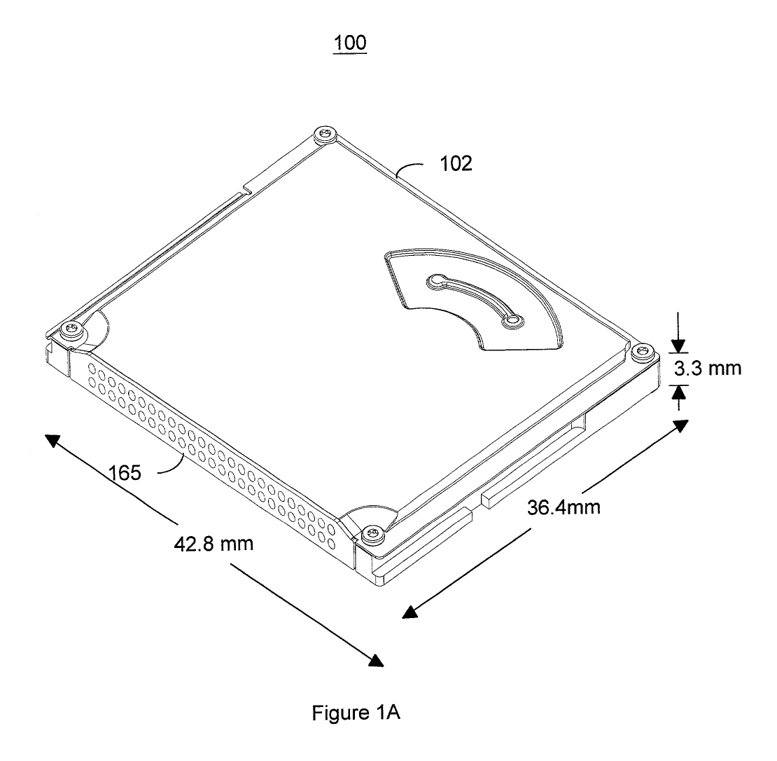

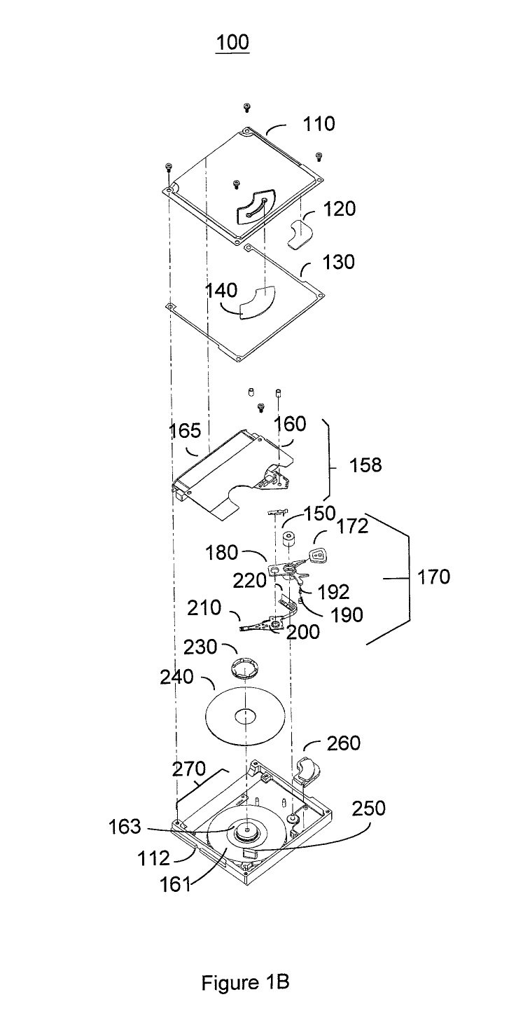

To more particularly illustrate the method and system in accordance with the present invention, refer now to FIG. 1A, depicting an external view of one embodiment of a disk drive 100 in accordance with the present invention. The disk drive 100 is preferably compatible with a CompactFlash™ standard. The disk drive 100 has a housing 102 that preferably includes a cover and a base (not depicted separately in FIG. 1A). Also shown is the electrical connector 165 for the disk drive 100. The connector 165 is compatible with electric interface used by a CF card. Furthermore, as can be seen by the dimensions for the housing 102 and thus the disk drive 100, the entire disk drive 100 is preferably 42.8 mm×36.4 mm×3.3 mm. Thus, the disk drive 100 is dimensionally consistent with the CompactFlash™ standard.

FIG. 1B is a diagram of one embodiment of a disk drive 100 in accordance with the present invention, including internal portions of the disk drive 100. The housing 102 of the disk drive 100 includes a cover 110 and a base 112. The cover 110 and base 112 form a cavity within the housing 102 in which the internal portions of the disk drive 100 are housed. The internal portions of the disk drive 100 includes a top yoke plate 120 for a voice coil motor used in operating an actuator 170, a gasket 130, a breather filter 140, a pivot bearing assembly 150, electronics 158 including a flex circuit 160, an actuator 170 including an actuator coil 172, an actuator body 180 and a crash stop 190 including a magnetic pin 192. The disk drive 100 also includes a head gimbal assembly 200 having a recording head 210, a second flex circuit 220, a disk clamp 230, a disk 240, a recirculation filter 250 and a bottom yoke assembly 260. The top yoke plate 120, the bottom yoke assembly 260 and the actuator coil 172 are part of a voice coil motor used to move the head between the inner and outer recording radii of the disk 240.

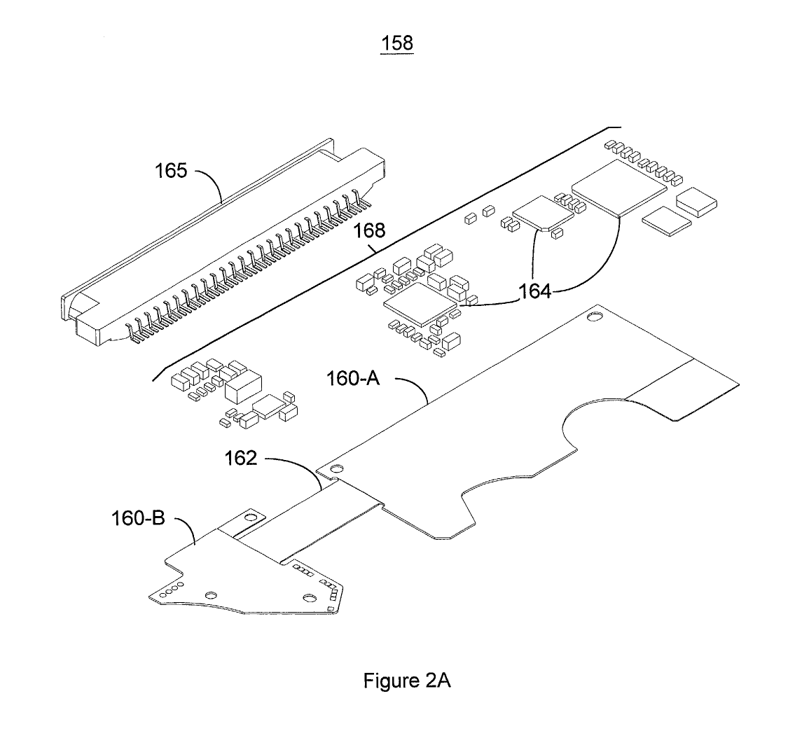

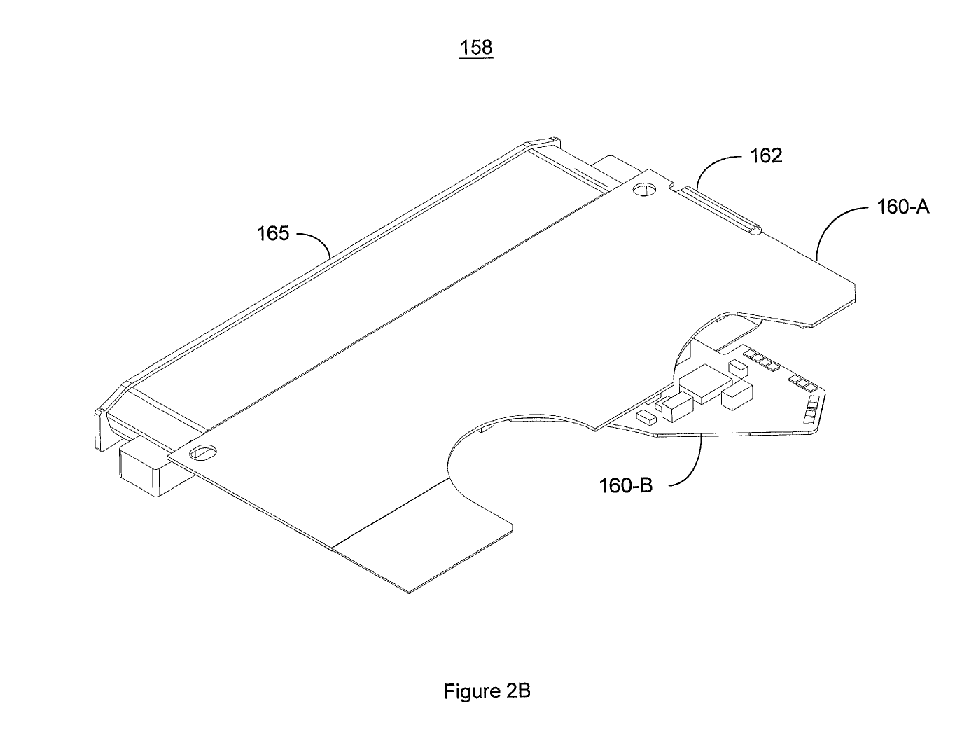

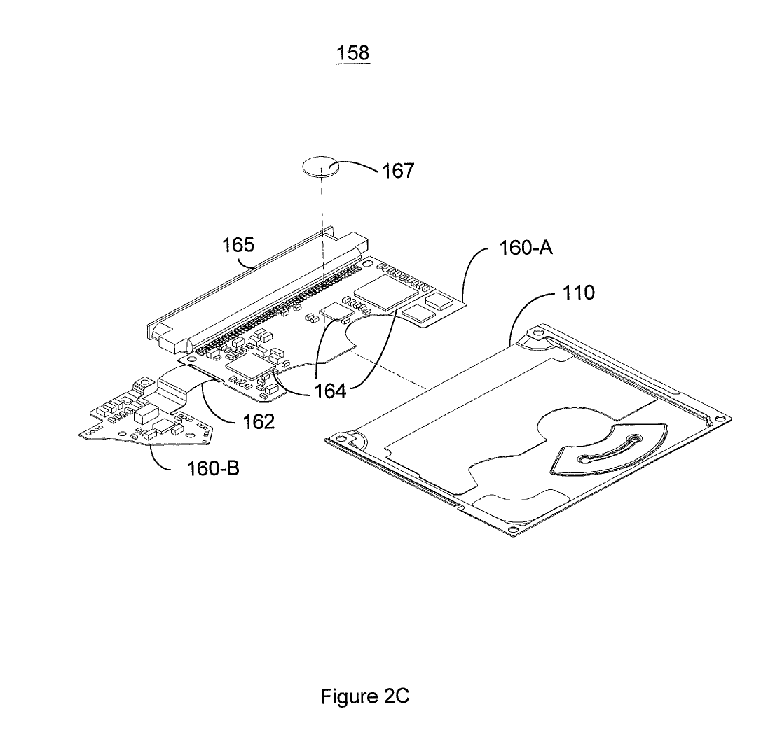

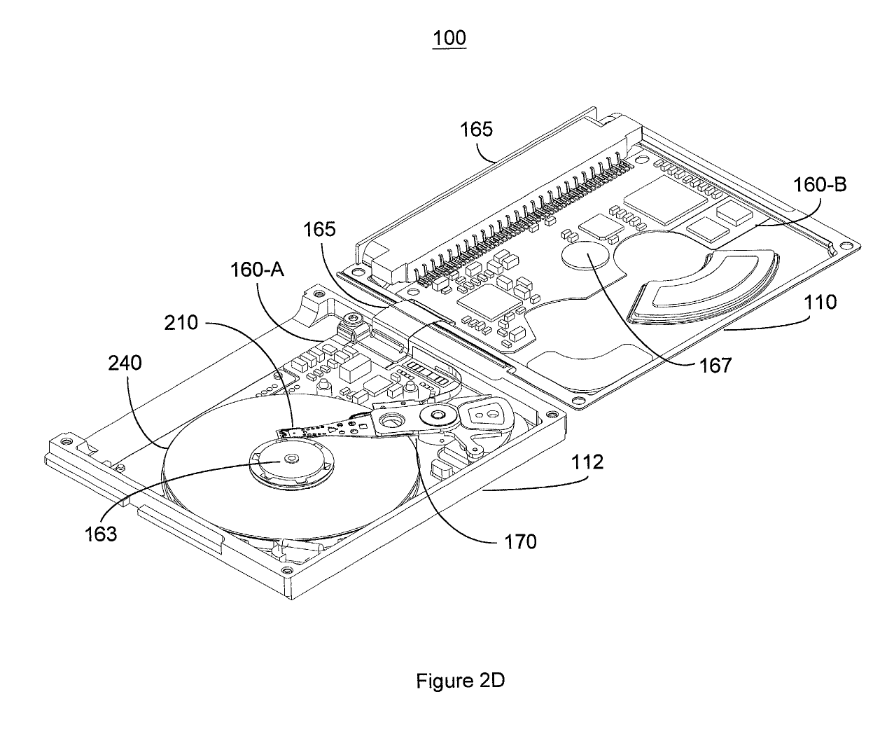

The disk drive 100 includes several innovations which allow the disk drive 100 to be compatible with the reduced size standard, particularly the CompactFlash™ standard. One of these innovations include electronics 158 provided on the flex circuit 160. FIGS. 2A-2D depict one embodiment of these electronics. FIG. 2A is a diagram of one embodiment of the electronics 158 for a disk drive in accordance with the present invention prior to assembly. FIG. 2B is a diagram of one embodiment of the electronics 158 for a disk drive 100 in accordance with the present invention prior to attachment to the cover 110. FIG. 2C is a diagram of one embodiment of the electronics 158 for a disk drive 100 in accordance with the present invention as assembled. FIG. 2D is a diagram of one embodiment internal portions of the disk drive 100 in accordance with the present invention which depicts the mounting of both portions 160-A and 160-B of the flex circuit 160.

Referring to FIGS. 2A-2C, the electronics 158 include the flex circuit 160 which preferably has two portions, 160-A and 160-B, electrical components 168 that includes integrated circuits 164 and connector 165. Note, however, that in an alternate embodiment, the flex circuit 160 is a single unit, or piece, that contains all of the electrical components 168. The flex circuit 160 preferably has four layers of circuitry which are used to connect various electrical components 168. The flex circuit 160 is generally no more than 0.205 mm thick. Thus, the entire thickness of the flex circuit 160 plus the electrical components 168 is a maximum of 1.605 mm. Furthermore, in areas where space is of concern, such as over the disk 240 (not shown in FIGS. 2A-2C), the combination of the flex circuit 160 and the electrical components 168 has a thickness of significantly less than 1.605, preferably approximately 0.8 mm. As a result, the flex circuit 160 can be used as a base for the electronics 158 in a disk drive 100 that is compatible with the CompactFlash™ standard. Moreover, in a preferred embodiment, the disk 240 is 27.44 mm in diameter. As are result, the disk 240 covers most of the area within the cavity of the housing 102. Thus, the electronics 158 are preferably mounted above the disk 240 and/or beneath the cover 110. Note that although the flex circuit 160 is preferably used for the base of the electronics 158, another very thin circuit board can be used.

In addition to being thin, the flex circuit 160 provides another advantage. The flex circuit 160 is relatively free of contaminants. As a result, the flex circuit 160 can be used in the disk drive 100 while the desired level of cleanliness can be maintained within the disk drive 100.

The flex circuit 160 has two portions, 160-A and 160-B, each of which serves as a substrate for some of the electronic components 168 and which includes multiple layers of circuitry. Connecting the portions 160-A and 160-B is a connector 162. In a preferred embodiment, the connector 162 is a bridge between the portions 160-A and 160-B that is preferably also a made of a flex circuit. However, in an alternate embodiment, the connector 162 could be a separate, removable connector that couples separate portions 160-A and 160-B. Each of the portions 160-A and 160-B of the flex circuit 160 preferably includes four layers of circuitry, while the connector 162 preferably includes two layers of circuitry. The connector 162 preferably includes two layers of circuitry so that the connector 162 remains more flexible, allowing the portions 160-A and 160-B to be folded over. Because of the presence of the connector 162, the portions 160-A and 160-B of the flex circuit 160 can be folded over, as shown in FIG. 2B. Thus, the flex circuit 160 and the electronics 158 required for the disk drive 100 can fit within the desired dimensions of the disk drive 100.

The electronic components 168 include those used by most disk drives. The electronics 168 include the pre-amp and supporting circuitry as well as the system electronics. In a preferred embodiment, the system electronics are provided on the portions 160-A of the flex circuit 160. Also in a preferred embodiment, the pre-amp and supporting circuitry are provided on the portion 160-B of the flex circuit 160. The system electronics on the portion 160-A of the flex circuit 160 include integrated circuits 164. The integrated circuits 164 include a controller chip and integrated circuits for the motor driver and read channel. The motor driver preferably drives the spindle motor (included in the motor assembly 161) for the disk 240 and the voice coil motor for the actuator 170. Although these functions are currently split between three integrated circuits 164, as integration continues, fewer and/or different integrated circuits 164 could be used. The integrated circuits 164 are preferably not packaged, but have their input/output pads redistributed with increased spacing to allow the integrated circuits 164 to be mounted directly to the flex circuit 160, in a similar manner to flip-chip technology. The electronic components 168 also include preamplifiers, power regulators, resistors, capacitors and other components used in conjunction with the integrated circuits 164. The integrated circuits 164 and other electrical components 168 are preferably mounted to the flex circuit 160 using a reflow solder process. As described above, the total thickness of the flex circuit 160 plus the electronic components 168 is not more than 1.605 mm. Thus, the electronics 158 required to utilize the disk drive 100 can be provided within a package that complies with a reduced size standard, preferably a CompactFlash™ standard.

After it is assembled with the electronic components 168, the flex circuit 160 is mounted to the housing 102. The flex circuit 160 is preferably attached to the housing 102 using an adhesive. In a preferred embodiment, the portion 160-A of the flex circuit 160 is mounted to the cover 110, as shown in FIG. 2C. Thus, in a preferred embodiment, portion 160-A is mounted to the cover 110, while portion 160-B folds under (over as shown in FIG. 2C) the portion 160-A. Because the flex circuit 160 is mounted to the cover 110, the electronics 158 become stiff, making them easier to handle during manufacturing. In addition, the cover 110 can act as a heat sink for the system electronics residing on the portion 160-A. The cover 110 can also be used as a shield to reduce noise entering the drive or coming from the drive.

The portion of the flex circuit 160-B is preferably mounted to the base 112 as shown in FIG. 2D. In addition, the spindle motor 161 for the disk 240 is mounted to the base 112. The base 112 thus acts as a heat sink for the pre-amp electronics residing on the portion 160-B of the flex circuit. The base 112 can also act as a heat sink for the spindle motor 161. Once joined, the base 112 and the cover 110 can not only act as a heat sink for the electronics 158, as well as the spindle motor 161, but also radiates the heat generated by the disk drive 100 to the surrounding environment.

The connector 165 is used to interface the disk drive 100 with the desired external device, such as a computer system. Because the connector 165 interfaces with the housing 102, the connector 165 is a sealed connector. Thus, the connector 165 provides an external interface for the disk drive 100.

Because the electronics 158 are provided on the flex circuit 160 in the manner described above, the electronics 158 can be provided within the housing 102 of the disk drive 100. Thus, the electronics 158 including system electronics and pre-amplifier electronics are provided in the same cavity as the disk 240 in a reduced size standard, such as a conventional CompactFlash™.

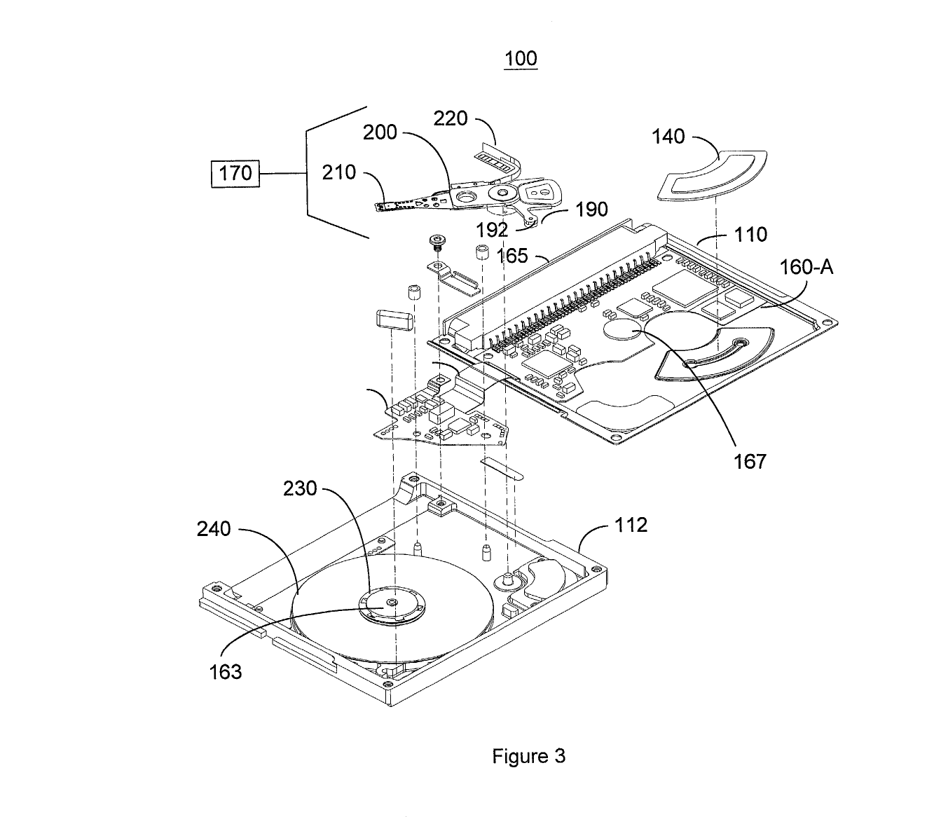

FIG. 3 is an exploded view of one embodiment of internal portions of the disk drive 100 in accordance with the present invention. Some of the other innovations that are preferably provided in the disk drive 100 in addition to the electronics 158 on the flex circuit 160 are depicted in FIG. 3. FIG. 3 depicts the head gimbal assembly 200 and the attached flex circuit 220. The flex circuit 220 is a second flex circuit 220. The second flex circuit 220 carries electrical signals to and from the head 210. The second flex circuit 220 also acts as part of a latch for the head gimbal assembly 200. The flex circuit 220 acts as a spring which tends to push the head 210 toward a parked position in the disk drive 100. Thus, when the disk drive 100 is not being used and the head 210 is desired to be parked, the head 210 is is automatically pushed toward the parked position. Thus, second flex circuit 220 acts as part of a latch.

Also shown in FIG. 3, as well as in FIG. 1B, is the crash stop 190. The crash stop 190 both forms part of the latch and acts as a crash stop. The crash stop 190 is designed to absorb shocks in the case that the disk drive 100 loses control and the head 210 moves in an uncontrolled manner across the disk 240. In addition, the crash stop pin 192 aids in latching the head 210 in a parked position. As discussed above, the second flex circuit 220 acts as part of a latch to push the head 210 toward a parked position when not in used. In addition, the crash stop 190 acts as part of the latch. The crash stop 190 includes a ferrous metal pin 192. When the head 210 is parked, in a latched position, the crash stop 190 is in proximity to a magnet that moves the actuator 170. The ferrous metal pin 192 is attracted to the magnet. As a result, when the head 210 is parked, the ferrous metal pin 192 of the crash stop 190 tends to keep the head in the parked position. Thus, functions of a crash stop and a latch are integrated into a single component, the crash stop 190. Thus, the cost of and space occupied by components which provide these functions are reduced.

In a preferred embodiment, a head limiter is also provided in the disk drive 100. In particular, the flex circuit 160 includes a head limiter 167. When the head 210 is parked, the spacing between the head 210 and the head limiter 167 of the flex circuit 160 is set so that the head limiter 167 does not allow the head 210 to come very far off of the disk 240 even when a shock is applied. Thus, the head 210 is kept relatively horizontal so that sharp corners of the head 210 do not strike the disk 240 and damage the disk 240. In a current embodiment, the head limiter 167 is 0.25 mm in thickness. However, the head limiter 167 is preferably designed to fill the space between the head 210 and the remainder of the disk drive 100.

In addition to the above-mentioned features, in a preferred embodiment, the disk clamp 230 is removable and compact. The disk clamp 230 is preferably a bonded clamp that is held onto the motor hub 163 and disk 240 using adhesive. Also in a preferred embodiment, the disk clamp 230 can be removed from the motor hub 163 and disk 240, for example if the disk drive 100 is desired to be repaired or otherwise worked on. At the same time, the disk clamp 230 is relatively compact. Thus, the disk clamp 230 can occupy less space in the disk drive 100 than a conventional mechanism for holding the disk 240 in place.

Referring back to FIG. 1B, in a preferred embodiment, the motor assembly 161 for the disk drive 100 aids in allowing the disk drive to be compatible with a reduced size standard such as the CompactFlash™ standard. The motor assembly 161 preferably includes a small, compact spindle motor for spinning the disk 240. In a preferred embodiment, the base 112 is thin in order to ensure that the disk drive 100 is compatible with a CompactFlash™ form factor. In order to prevent vibrations in the disk drive 100 due to the spindle motor 161, adhesive is provided between the windings of the spindle motor 161 and the base 112. Further adhesive can be provided in open spaces in and/or around the motor assembly 161. The adhesive improves the rigidity of the base 112 and motor assembly 161 combination. Furthermore, the viscosity of the adhesive can be tailored to provide the desired stiffness for the combination. As a result, a thin base 112 can be used and the desired reduced size standards complied with without sacrificing performance of the disk drive 100.

Thus, the disk drive 100 can function as desired. In addition, the disk drive 100 can be compatible with a reduced size standard. In a preferred embodiment, the disk drive 100 is compatible with a CompactFlash™ standard. Also in a preferred embodiment, the electronic components 168 provided on a flex circuit 160, the integrated latch and crash stop 260, 190 and 192, head limiter 167, disk clamp 230 and reinforced spindle motor 161 and base 112 combination improve the performance of the disk drive 100 and allow the disk drive to be made more compact, preferably compliant with a CompactFlash™ standard.

A method and system has been disclosed for providing a disk drive compatible with a reduced size standard. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A disk drive for storing and retrieving data comprising:
a housing having a cavity therein;
a motor coupled with the disk for spinning a disk that stores the data;
a head;
an actuator coupled with the head, the actuator for moving the head in proximity to the disk;
a flex circuit including electronics coupled with the head for controlling the actuator and the head and for providing a write signal to and a read signal from the head, the electronics further including at least one integrated circuit; and
an external electrical interface coupled with the electronics;
wherein the motor, the head, the actuator, and the electronics are contained within the cavity of the housing, and wherein the housing and the external electrical interface are compatible with a reduced size standard.

2. The disk drive of claim 1 wherein the housing is approximately 43 mm by approximately 36 mm by approximately 3.3 mm.

3. The disk drive of claim 1 wherein the reduced size standard is a CompactFlash™ standard.

4. The disk drive of claim 1 wherein the flex circuit acts as a system board.

5. The disk drive of claim 4 wherein the housing further includes a base and a cover and wherein the flex circuit is attached to the cover.

6. The disk drive of claim 5 wherein the cover further acts as a heat sink for the system board.

7. The disk drive of claim 4 wherein the flex circuit and the at least one integrated circuit have a total thickness of less than 1.605 mm.

8. The system of claim 1 further comprising:
a preamplifier coupled with the head and the electronics; and
a second flex circuit for holding the preamplifier.

9. The disk drive of claim 8 wherein the housing further includes a base and a cover and wherein the second flex circuit is attached to the base.

10. The disk drive of claim 9 wherein the base further acts as a heat sink for the preamplifier.

11. The disk drive of claim 8 wherein the motor is also mounted to the base.

12. The disk drive of claim 1 wherein the housing further includes a cover and wherein the electronics are mounted above the disk and/or beneath the cover.

13. The disk drive of claim 1 wherein the disk drive further include a preamplifier and wherein the flex circuit is a single unit and wherein flex circuit includes the electronics and the preamplifier.

14. A method for storing and retrieving data on a disk drive comprising the steps of:
allowing a user to magnetically store data on a disk in the disk drive, the disk drive including a housing having a cavity therein, a motor for spinning a disk that stores the data, a head, an actuator coupled with the head, a flex circuit including electronics coupled with the head and an external interface coupled with the electronics, the actuator for moving the head in proximity to the disk, the electronics for controlling the actuator and the head and for providing a write signal to and a read signal from the head, the electronics further including at least one integrated circuit, the motor, the head, the actuator, and the electronics being contained within the cavity of the housing, and the housing and the external electrical interface are compatible with a reduced size standard; and
allowing the user to retrieve the data magnetically stored on the disk in the disk drive.

15. The method of claim 14 wherein the housing is approximately 43 mm by approximately 36 mm by approximately 3.3 mm.

16. The method of claim 14 wherein the reduced size standard is a CompactFlash™ standard.

17. The method of claim 14 wherein the flex circuit acts as a system board.

18. The method of claim 17 wherein the housing further includes a base and a cover and wherein the flex circuit is attached to the cover.

19. The method of claim 18 wherein the cover further acts as a heat sink for the system board.

20. The method of claim 17 wherein the flex circuit and the at least one integrated circuit have a total thickness of less than 1.605 mm.

21. The method of claim 14 wherein the disk drive further includes:
a preamplifier coupled with the head and the electronics; and
a flex circuit for holding the preamplifier.

22. The method of claim 21 wherein the housing further includes a base and a cover and wherein the flex circuit is attached to the base.

23. The method of claim 22 wherein the base further acts as a heat sink for the preamplifier.

24. The method of claim 21 wherein the motor is also mounted to the base.

25. The method of claim 14 wherein the housing further includes a cover and wherein the electronics are mounted above the disk and/or beneath the cover.

26. The method of claim 14 wherein the disk drive further include a preamplifier and wherein the flex circuit is a single unit and wherein flex circuit includes the electronics and the preamplifier.
